(19) United States
(12) Patent Application Publication
(10) Pub. No.: US 2005/0065833 A1
(43) Pub. Date: Mar. 24, 2005

(54) Production scheduling management method and production scheduling management program

(76) Inventors: Takashi Okaji, Osaka (JP); Hirofumi Tachiyama, Osaka (JP); Yuusaku Hirose, Osaka (JP); Shigeki Akiyama, Osaka (JP); Takeo Yamamoto, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/668,697

(22) Filed: Sep. 23, 2003

(51) Int. Cl. G06F 17/60

(52) U.S. Cl. 705/8

(57) ABSTRACT

Executing the steps of: receiving information of customer orders and information of prospect orders and storing into a received order database 20; dividing orders stored in said received order database 20 based on a reference master having various kinds of information about production materials registered therein, and storing the information of the orders which have been subjected to the division process to a received order division database 21; applying a process development to the orders which have been subjected to the division process, based on a basic unit master and storing into a process development database 22; specifying an optimum production starting date based on the information of orders which have been subjected to the process development and a production pattern stored in a production pattern database, performing loading, and storing results of the loading into a production planning database 23; and creating delivery date answer information, based on said optimum production starting date stored in the production planning database 23.

### BACKGROUND OF THE INVENTION

1. Field of the Invention

The present invention relates to a production scheduling management method and a production scheduling management program in which customer orders and prospect orders are received and registered to a database, making it possible to automatically answer a delivery date to a customer based on various kinds of masters.

2. Description of the Related Art

In a manufacturing job site of producing products, daily production activities are based on production scheduling. A production scheduling includes information enabling production to be carried out as planned so as to match a planned delivery date, and is created based on received order information such as customer orders and prospect orders and also on resource information such as production processes and facilities.

In recent years, in manufacturing job sites, it is required to produce various kinds of products in small quantities, which forces production scheduling to get complicated as compared with the days when a small variety of products were produced in large quantities. This situation becomes burdensom to unskilled workers responsible for the creation of production schedulings. When there is an order from a customer, they must answer a delivery date to the customer, and it must be quick. The task for answering also becomes burdensome to unskilled workers as production scheduling gets more and more complicated.

### SUMMARY OF THE INVENTION

The present invention has been contrived in view of the aforementioned situation and its object is to provide a production scheduling management method and a production scheduling management program which enable an unskilled worker to create production schedulings matching a small variety of products in large quantities and to answer delivery dates to customers quickly.

In order to achieve the object, the production scheduling management method of this invention is characterized by making a computer execute the steps of:
receiving information of customer orders and information of prospect orders and storing into a received order database;
dividing orders stored in the received order database based on a reference master having various kinds of information about production materials registered therein, and storing the information of the orders which have been subjected to the division process to a received order division database; applying a process development to the orders which have been subjected to the division process, based on a basic unit master and storing into a process development database; specifying an optimum production starting date based on the information of orders which have been subjected to the process development and a production pattern stored in a production pattern database, performing loading, and storing results of the loading into a production planning database; and creating delivery date answer information, based on the optimum production starting date.

The operations and effects of the production scheduling management method thus structured are as follows. First, information about customer orders and information about prospect orders are received. The term “customer order” indicates information based on actual orders from customers, and the term “prospect order” indicates information to be taken into a production scheduling by expecting future orders. Received orders are stored in a received order database.

A reference master (master file) stores various kinds of information as reference to create production schedulings, the information corresponding to the required amount of use of production resources including parts, production processes, and facilities, hours to be used, and the like. Based on this reference master, orders stored in the received order database are subjected to a division process. The order information which has been subjected to the division process is stored in a received order division database. And the orders which have been subjected to the division process are subjected to a process development process, based on a basic unit master. These results are stored in a process development database.

A production pattern database stores production patterns. The term “production pattern” indicates a pattern showing the sequence of production of various kinds of products. The production pattern is previously registered in a database, based on past production results and other data. Based on this production pattern and the order information which has been subjected to the process development process as described above, an optimum production starting date is specified, and loading is performed. The results of the loading are stored in a production planning database. Based on the optimum production starting date, delivery date answer information can be created.

Each of the aforementioned processes can be realized by a program installed in a computer. Therefore, a worker not skilled in creating production schedulings can create and control the production schedulings without a heavy burden. Furthermore, performing loading based on the optimum production starting date enables delivery dates to be answered quickly. Hereby, this can provide a production scheduling management method which enables an unskilled worker to create production schedulings matching the production of a small variety of products in large quantities and the delivery date to be answered quickly.

On preferred embodiment of this invention can make a change to a production scheduling stored in the production planning database.

It sometimes happens that after the delivery date obtained as described above is given to a customer, the customer requests to change the delivery date. This request for a delivery date change from the customer can be responded by designing load-piled production scheduling to be changeable.

Another preferred embodiment of this invention can compare a production scheduling stored in the production planning database with the production results and display these in a comparative manner by a display means.

The comparative display of a production scheduling and the production results makes it possible to check the progress of production scheduling and the degree of attainment of the delivery date visually and easily.

Further another preferred embodiment of this invention sets the production pattern in such a manner that a production scheduling is repeated periodically and that the compliance rate of delivery date of a target product becomes a maximum.

Using this production pattern makes it possible to provide customers with proper replies about delivery dates.

### BRIEF DESCRIPTION OF THE DRAWINGS

FIG. 1 is a view showing a system structure executing a production scheduling management method;

FIG. 2 is a view showing a system structure in the case where a production scheduling is changed; and

FIG. 3 is a view showing a structure example of a Gantt chart screen.

### DETAILED DESCRIPTION OF THE PREFERRED EMBODIMENTS

The preferred embodiments of the production scheduling management method of the present invention will be described as follows, with reference to the drawings.

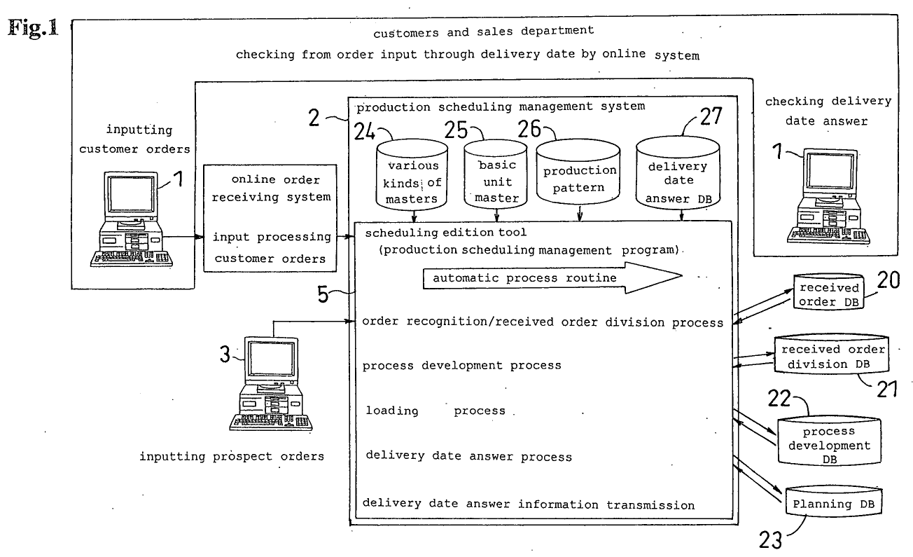

FIG. 1 is a view showing the structure of a production scheduling management system for executing a production scheduling management method.

A customer/sales department has a number of personal computers 1. The substance of the production scheduling management system 2 is a computer (server) in which a management program for constructing a system has been installed. The personal computers 1 in the customers and sales department and the production scheduling management system 2 are connected over a network (online order-receiving system). The network is not restricted to a specific form, and can be constructed by using a well-known infrastructure such as the Internet, an intra-company LAN, or telephone lines. A production control department and other departments also have a number of personal computers 3, which are also connected over the network.

Through personal computers 1 installed in the customers and sales department is entered information about customer orders. The term “customer order” indicates information about an order received from a customer and is composed of a product number, a product name, a delivery date, a shipping quantity, a receiver's address, and the like.

Through the personal computers 3 installed in the production control department is entered information about prospect orders. The term “prospect order” indicates information about production arrangements incorporated into a production scheduling while expecting temporary inventories, so as to level out and stabilize production prior to the reception of orders from customers. This information is entered by expecting future orders while considering past order information.

The following is a description of the features of the production scheduling management system 2 (hereinafter referred to simply as “management system”). The order information entered through the personal computers 1 and 3 is automatically received over the network (order-receiving feature). The management system 2 is composed of a number of master files and databases and a scheduling edition tool 5. The scheduling edition tool 5 is software to support production scheduling planning, and takes in the know-how owned by skilled creators system logically. In addition, a graphical screen called a Gantt chart is displayed on a computer monitor to facilitate inputting and checking work of the operator. The term “production scheduling” indicates a time table of the production activities of a product or work in process over a certain period of time.

The various kinds of masters (masters represent master files. This holds true in the following) indicate information corresponding to a logbook including the required amount of use of production resources such as parts, production processes, and facilities and the hours to be used, the information corresponding to a reference master. These are also files storing information to be used as the reference for creating production schedulings. Once master information is created, the contents never change within a certain period of time. Of the various kinds of masters, a production pattern master has information about products registered therein. Products produced based on a production scheduling are registered in the product pattern master. When a new product has been developed, the maintenance screen in the product pattern master is opened for new registration or modification.

A customer order is transmitted in real time over the network. Upon receipt of customer order information, the product pattern master is checked to see if the product is registered or not. Furthermore, other various masters are checked to determine whether order-receiving requirements are conformed. To be more specific, it is checked whether requirements of order-receiving data (a product number, a delivery date, a shipping quantity, and a receiver's address) are conformed or not. When the requirements are conformed, the customer order information is stored in a received order database 20. A prospect order is manually entered through a personal computer 3 and stored in the received order database 20 in the same manner. When a customer order not conforming the order-receiving requirements is received, an error message is sent to the sender.

Received customer orders are automatically subjected to a received order division process when they exceed the reference, based on product-by-product production standards (proper unit amount of production) set at each of the various masters. The customer orders subjected to the received order division process and the customer orders not subjected to the received order division process are immediately stored in a received order division database 21.

Of the customer orders which have been subjected to the division process in the received order division database 21, orders corresponding to work in process are applied for an intermediate stock allocation, and when the intermediate stock allocation is possible, the delivery date to be answered can be immediately calculated from the designated delivery date and the completion lead time. Concerning the orders which have been subjected to the received order division process and are unable to have the intermediate stock allocation, the basic unit master is referred to for process development and required quantity development, thereby storing orders which have been subjected to the process development to a process development database 22. The term “basic unit master” indicates a master file which defines a physical amount of source materials, parts, sub materials, man-hours and the like consumed per unit of product, that is, a physical unit rate per fixed unit of product or work.

Next, a production lead time is calculated based on the order information which has been subjected to the process development. Then, the production starting date suitable for the delivery date requested by a customer is calculated, and an optimum production starting date is specified and loading is performed based on the production pattern information registered in the production pattern database. The results of the loading are stored in a production planning database 23. The term “loading” means to assign workload between necessary processes in order to produce each product and work in process.

For example, when a customer order is about product “A” and a delivery date of Jul. 13, 2002, the process-by-process order in the process development database 22 specifies the most suitable date for the delivery date (the date nearest to the delivery date in the conditions that the total of planning days+completion lead time (the number of days) is not behind the delivery date (Jul. 13, 2002)) from among the production planning days corresponding to product “A” registered in the production pattern database 26 at constant intervals (several minutes to 30 minutes). And when the date is within the time frame for operation, loading is performed. The result is information about a delivery date answer.

The term “production pattern” used in the above description will be explained as follows. The production pattern defines the sequence of production of plural products, and is previously prepared based on the following four requirements:

(1) the production pattern is so set that a production scheduling is repeated periodically. Normally, the time period is one week, but it can be set less than one week or more than one week (e.g., six months).

(2) the size of production frame is set so as to make the compliance rate of delivery date of a target product maximum. The compliance rate of delivery date is an index indicating the degree of attainment to the delivery date requested by the customer, and is expressed by a ratio between the quantity of a product which can be produced until the delivery date designated by the customer and the total quantity of the product which should be produced as ordered.

(3) the sequence of production is set while securing productivity by reducing the number and hours of step replacement in the manufacturing job site. For example, different products using the same main material are produced integrally or successively.

(4) in addition to (1)-(3) above, the production pattern is intended to represent an optimum production pattern at that point in time, based on information such as demand adjustments obtained from information about market, customers and company. The method using this production pattern can maintain and manage the system efficiently without being affected by changes in production facilities or production requirements.

While considering these aspects, the production pattern is operated by laying emphasis on the experience of the person in charge and the newest information of the market. Demand prediction is carried out based on the production shipment records e.g., in the past three years. The registration of the production pattern into the database is conducted so as to conform the above requirements by the person in charge by using a personal computer. A once registered production pattern can be modified or deleted.

Based on the optimum production starting date stored in the production planning database 23, delivery date information is calculated. The delivery date information created is stored in a delivery date answer database 27. The delivery date answer information stored is checked at regular intervals and when there is information not transmitted yet, it is extracted and transmitted. As a result, the created delivery date answer can be transmitted to the customers and sales department by e-mail or another means.

As described hereinbefore, the order recognition process, received order division process, process development process, loading process, delivery date answer process, and delivery date answer information transmission process are automatically carried out by software (production scheduling management program). Furthermore, delivery date information can be calculated by specifying an optimum production starting date and performing loading, based on the production pattern information. These series of processes can be completed within one hour at the longest. Thus, it becomes possible to answer delivery dates to customers.

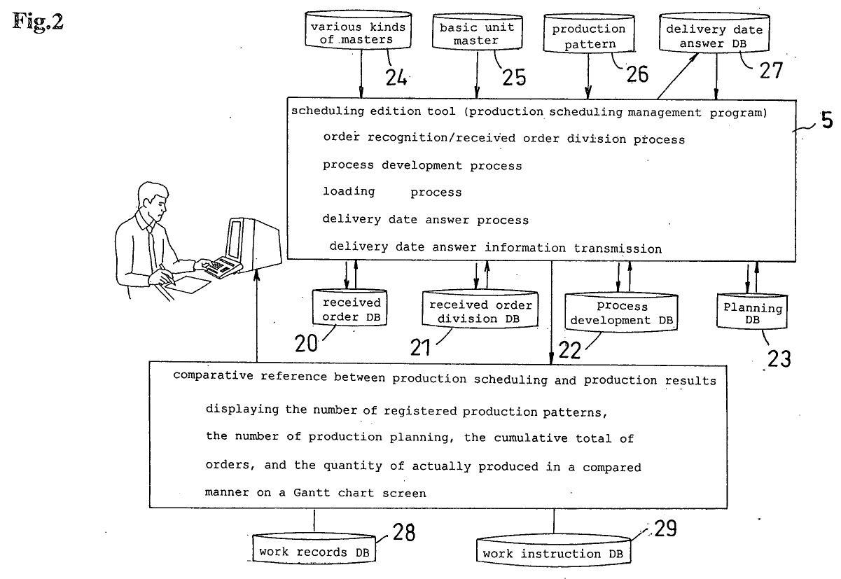

FIG. 2 shows a changing appearance of a load-piled production scheduling. Changing a production scheduling is done by the person in charge when the customer has requested a delivery date change to the above-mentioned automatic delivery date answer. Based on the contents stored in the production planning database 23, a work instruction database 29 is created to provide instruction to workers in the manufacturing job site. The operations in the manufacturing job site are performed based on this database. The records of producing operations in the manufacturing job site are registered in a work results database 28.

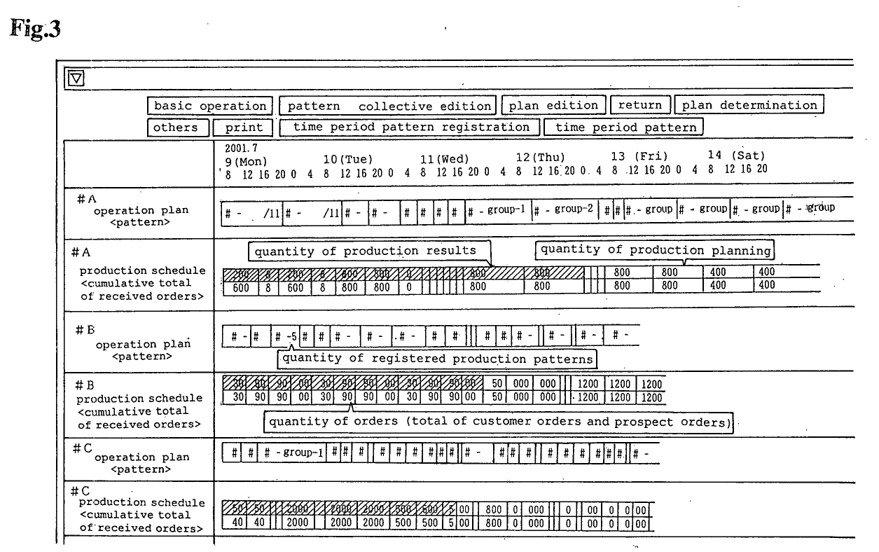

The comparative reference between the production scheduling and the production results can be performed based on these databases. This is shown in a Gantt chart as shown in FIG. 3. This screen shows operation plans (production patterns) in production lines “A”, “B”, and “C” and production planning. This production pattern has the date of starting to produce a certain product and the scheduled date of ending production registered therein. In each column of production planning, the numerals in the bottom represent the ordered quantities (the total quantity of customer orders and prospect orders) and the numerals in the top represent the quantities actually produced and the quantities of scheduling products. The numerals prior to the addition of the quantities actually produced indicate the quantities of planning products. Each column of operation planning shows the number of registered production patterns. The number of registered production patterns shows the standard quantity that can be produced within the time period (calculated based on the basic unit master). In this manner, production scheduling and production results can be visually compared, which enables the operator to recognize immediately whether or not the production scheduling is being done as scheduled.

As mentioned above, “production pattern” can achieve the automation of the creation of production scheduling and delivery date answer, by adding the experience, guess work, and prediction of the person in charge and business information to the present production scheduling as the base.

A well-known art similar to this invention is a production plan scheduling device disclosed in Japanese Laid-open Patent Application No. 11-126221. In this device, the concept of “production allocation pattern” is used, and the production allocation pattern storage part stores production allocation patterns previously allocated with the sequence of production and time frame of production of all products so as to minimize switching loss of row materials and loss time. To be more specific, the device is composed of a two-stage computer logic to automatically create “production allocation pattern” from “production allocation basic information master”, and to automatically assign received orders and prospect orders to “production allocation pattern”.

In contrast, the system of this invention, which uses the Gantt chart screen shown in FIG. 3 to directly input “production pattern” itself, holds superiority in the following points over the well-known art.

(1) for realizing the experiments and policies of the person in charge of production scheduling edition, it is possible to create “production pattern” straightly and easily as computer data without using the “production allocation basic information master”. In the case where the two-stage computer logic is used as in the well-known art, automatically creating a production scheduling which can satisfy the person in charge of edition becomes more difficult in the degree of completion of system logic and the accuracy of input information. Hence, the system structure of this invention can be simplified and the efficiency of system operation can be increased.

(2) using a Gantt chart planning edition screen can input and modify “production pattern” directly. This increases operation efficiency.

(3) checking “production pattern” by watching a Gantt chart planning edition screen can get the image of “production scheduling” before received orders and prospect orders actually come.

(4) operating in corporation with the record collection system makes it possible to compare “production pattern”, “production planning”, “production results”, and “received orders and prospect orders” with each other, which facilitates the improvement of the quality of “production pattern”.

1. A production scheduling management method for making a computer execute the steps of:
receiving information of customer orders and information of prospect orders and storing into a received order database;
dividing orders stored in said received order database based on a reference master having various kinds of information about production materials registered therein, and storing the information of the orders which have been subjected to the division process to a received order division database;
applying a process development to the orders which have been subjected to the division process, based on a basic unit master and storing into a process development database;
specifying an optimum production starting date based on the information of orders which have been subjected to the process development and a production pattern stored in a production pattern database, performing loading, and storing results of the loading into a production planning database; and
creating delivery date answer information, based on said optimum production starting date.

2. The production scheduling management method according to claim 1 a step of changing a production scheduling stored in said production planning database.

3. The production scheduling management method according to claim 1, for further making said computer execute a step of making a display means display a production scheduling stored in said production planning database and production results in a compared manner.

4. The production scheduling management method according to claim 1, wherein said production pattern is set in such a manner that a production scheduling is repeated periodically and that the compliance rate of delivery date of a target product maximum.

5. A production scheduling management programming method for making a computer execute the steps of:
receiving information of customer orders and information of prospect orders and storing into a received order database;
dividing orders stored in said received order database based on a reference master having various kinds of information about production materials registered therein, and storing the information of the orders which have been subjected to the division process to a received order division database;
applying a process development to the orders which have been subjected to the division process, based on a basic unit master and storing into a process development database;
specifying an optimum production starting date based on the information of orders which have been subjected to the process development and a production pattern stored in a production pattern database, performing loading, and storing results of the loading into a production planning database; and
creating delivery date answer information, based on said optimum production starting date.
